(19) United States
(12) Patent Application Publication
(10) Pub. No.: US 2026/0260399 A1
(43) Pub. Date: Sep. 3, 2026

(54) ELECTRONIC DEVICE AND METHOD FOR ENHANCING PARTIAL AREA OF IMAGE

(71) Applicant: Samsung Electronics Co., Ltd., Suwon-si (KR)

(72) Inventors: Chulju YANG, Suwon-si (KR); Kyuwon KIM, Suwon-si (KR); Jongkyu KIM, Suwon-si (KR); Hyunsoo KIM, Suwon-si (KR); Heekuk LEE, Suwon-si (KR)

(21) Appl. No.: 19/653,719

(22) Filed: Apr. 21, 2026

Related U.S. Application Data
(63) Continuation of application No. PCT/KR2024/096454, filed on Oct. 31, 2024.

(30) Foreign Application Priority Data
Dec. 29, 2023 (KR) 10-2023-0197866
Jan. 16, 2024 (KR) 10-2024-0007060

(51) Int. Cl. G06T 11/10; G06T 5/60; G06V 10/20

(52) U.S. Cl. CPC G06T 11/10; G06T 5/60; G06V 10/255

(57) ABSTRACT

An electronic device is provided. The electronic device includes an image, a first region including a designated object and a second region distinguished from the first region, changes a first luminance of pixels included in the first region to a second luminance in order to move a luminance distribution range of the pixels, changes a first color of at least one of the pixels to a second color such that a luminance deviation of the pixels increases, and changes a color of at least one of the pixels to a third color based on a weighted sum of the first color and the second color, thereby providing a corrected image for the image.

### CROSS-REFERENCE TO RELATED APPLICATION(S)

This application is a continuation application, claiming priority under 35 U.S.C. § 365 (c), of an International application No. PCT/KR2024/096454, filed on Oct. 31, 2024, which is based on and claims the benefit of a Korean patent application number 10-2023-0197866, filed on Dec. 29, 2024, in the Ministry of Intellectual Property (MOIP), and of a Korean patent application number 10-2024-0007060, filed on Jan. 16, 2024, the disclosure of each of which is incorporated by reference herein in its entirety.

### BACKGROUND

### 1. Field

The disclosure relates to an electronic device and a method for enhancing a partial region of an image.

### 2. Description of Related Art

An electronic device may obtain an image captured through a camera or an image downloaded from an external electronic device. The electronic device may calibrate the obtained image. For example, the electronic device may clearly calibrate a partial region by changing a luminance and/or a color of the partial region included in the image.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for enhancing a partial region of an image.

Additional aspects will be set forth in part in the description which follows and, in part, will be apparent from the description, or may be learned by practice of the presented embodiments.

In accordance with an aspect of the disclosure, an electronic device is provided. The electronic device includes memory including one or more storage media storing instructions, at least one processor communicatively coupled to the memory, wherein the instructions, when executed by the at least one processor individually or collectively, cause the electronic device to estimate, from an image stored in the memory by using a first artificial intelligence model, a first region in which a defined object is included, and a second region distinct from the first region, change a first luminance of pixels included in the first region to a second luminance, based on a reference luminance, to shift a luminance distribution range of the first pixels included in the first region, change a first color of at least one pixel among the first pixels to a second color such that a luminance deviation of the first pixels is increased, provide a calibrated image for the image by changing a color of at least one pixel among the first pixels to a third color based on a weighted sum of the first color and the second color.

In accordance with another aspect of the disclosure, a method performed by an electronic device including memory is provided. The method includes estimating, from an image stored in the memory by using a first artificial intelligence model, a first region in which a defined object is included, and a second region distinct from the first region, changing a first luminance of first pixels included in the first region to a second luminance, based on a reference luminance, to shift a luminance distribution range of the pixels included in the first region, changing a first color of at least one pixel among the first pixels to a second color such that a luminance deviation of the first pixels is increased, and providing a calibrated image for the image by changing a color of at least one pixel among the first pixels to a third color based on a weighted sum of the first color and the second color.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates components of an electronic device according to an embodiment of the disclosure;

FIG. 3 illustrates an image according to an embodiment of the disclosure;

FIG. 4 is a flow chart illustrating an operation of calibrating an image by an electronic device according to an embodiment of the disclosure;

FIG. 5 illustrates a histogram obtained from an image according to an embodiment of the disclosure;

FIG. 6A illustrates a histogram for a first region of an original image according to an embodiment of the disclosure;

FIG. 6B illustrates a histogram for a first region of a calibrated image according to an embodiment of the disclosure;

FIG. 7 illustrates calibrating an image based on a weighted sum according to an embodiment of the disclosure;

FIG. 8 is a flow chart illustrating an operation of determining whether to calibrate an image based on detection of a defined object by an electronic device according to an embodiment of the disclosure;

FIG. 9 is a flow chart illustrating an operation of calibrating a first region of an electronic device according to an embodiment of the disclosure;

FIGS. 10A, 10B, and 10C illustrate processes in which an electronic device enhances a first region according to various embodiments of the disclosure;

FIGS. 11A, 11B, 11C, and 11D illustrate processes in which an electronic device enhances a first region according to various embodiments of the disclosure;

FIG. 12 illustrates an electronic device according to an embodiment displays favorite images according to an embodiment of the disclosure;

FIG. 13 is a flow chart illustrating an operation in which an electronic device changes a luminance of first pixels according to an embodiment of the disclosure;

FIG. 14 is a flow chart illustrating an operation in which an electronic device changes a color of first pixels according to an embodiment of the disclosure;

FIG. 15A illustrates a display displaying a first visual object according to an embodiment of the disclosure;

FIG. 15B illustrates a display displaying a second visual object according to an embodiment of the disclosure;

FIG. 15C illustrates a display displaying an original image and a calibrated image according to an embodiment of the disclosure; and

FIG. 16 illustrates a display displaying a fourth visual object according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

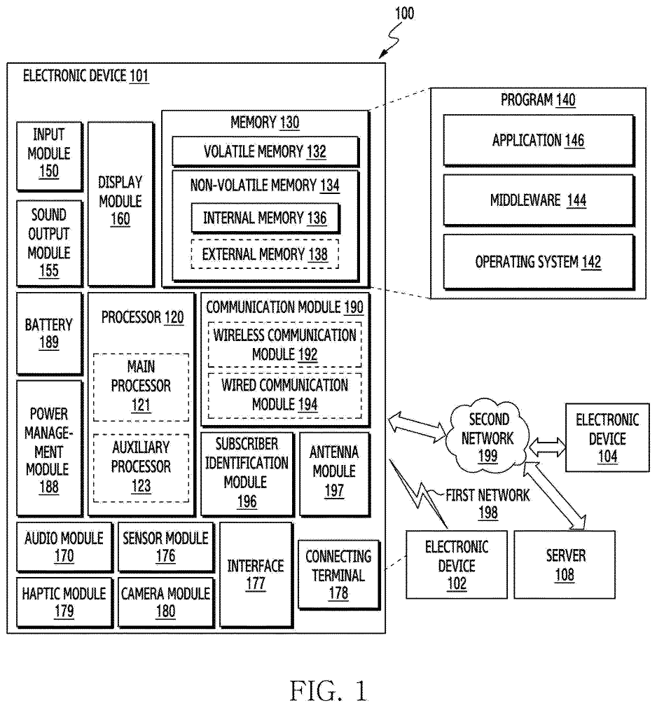

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mm Wave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

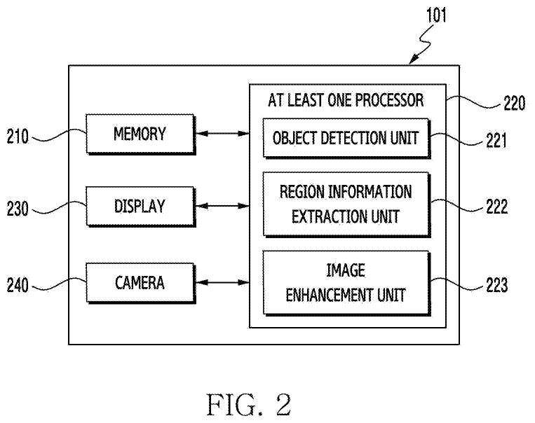

FIG. 2 illustrates components of an electronic device according to an embodiment of the disclosure.

Referring to FIG. 2, an electronic device (e.g., the electronic device 101 of FIG. 1) may include memory 210 (e.g., the memory 130 of FIG. 1), the one processor 220 (e.g., the processor 120 of FIG. 1), a display 230 (e.g., the display module 160 of FIG. 1), and/or a camera 240 (e.g., the camera module 180 of FIG. 1).

According to an embodiment of the disclosure, the memory 210 may store data, such as instructions for an operation of the electronic device 101, a basic program, an application program, and setting information. The memory 210 may be configured with volatile memory, nonvolatile memory, or a combination of the volatile memory and the nonvolatile memory. The memory 210 may store at least one image. For example, the memory 210 may store an image captured using the camera 240 or an image obtained from an external electronic device. The memory 210 may provide at least one stored image based on a request of the at least one processor 220. The memory 210 may include various memories. For example, the memory 210 may include buffer memory for temporarily storing at least a portion of an image obtained through the camera 240 for the next image processing operation, or memory (e.g., a server or a cloud) connected to an image signal processor (ISP). In the disclosure, in addition to the image stored in the memory 210, a calibrated image may include a copy image previewed through the display 230.

Any function or operation described in the specification may be processed by the at least one processor 220. According to an embodiment of the disclosure, the at least one processor 220 may include processing circuitry. The at least one processor 220 may include an application processor (AP) (e.g., a central processing unit (CPU)) and/or a communication processor (CP) (e.g., a modem), but is not limited thereto. The at least one processor 220 may include a graphics processing device (e.g., a GPU), a neural processing unit (NPU) (e.g., an artificial intelligence (AI) chip), a wireless-fidelity (Wi-Fi) chip, a Bluetooth Chip®, a global positioning system (GPS) chip, a near field communication (NFC) chip, connectivity chips, a sensor controller, a touch controller, a finger-print sensor controller, a display drive integrated (DDI) circuit, an audio CODEC chip, a universal serial bus (USB) controller, a camera controller, an image processing IC, a microprocessor unit (MPU), a system on chip (SoC), an integrated circuit (IC), or circuitry similar thereto.

According to an embodiment of the disclosure, the at least one processor 220 may control an operation of the electronic device 101. For example, the at least one processor 220 may cause the electronic device 101 to calibrate at least one image stored in the memory 210 by executing instructions stored in the memory 210. In the disclosure, calibration of an image may be referred to as highlighting a contrast effect on an object (e.g., a cloud) included in a partial region (e.g., a sky region) by enhancing the partial region of the image. However, it is not limited thereto. The term “calibrate” may include adjusting, correcting, editing, changing, revising, compensating, normalizing, tuning, or otherwise modifying one or more parameters.

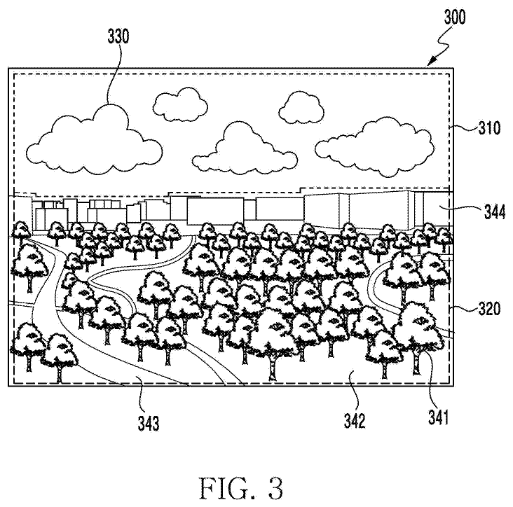

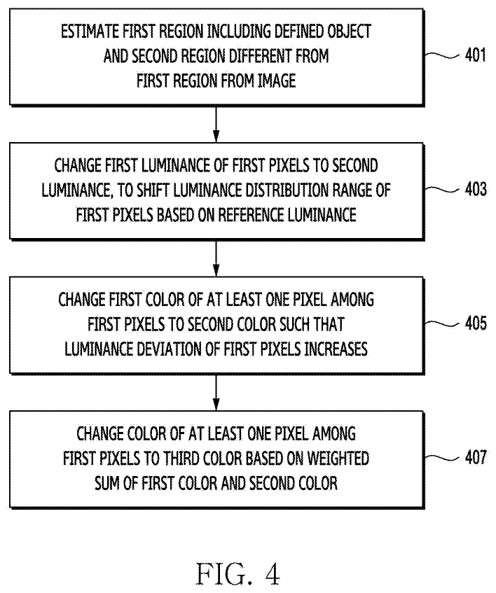

According to an embodiment of the disclosure, the at least one processor 220 may obtain an image from the memory 210. The at least one processor 220 may detect a defined object 330 (e.g., a tree 341, a lawn 342, a road 343, a building 344, a cloud, a sky, or the like, of FIG. 3) included in the image using an AI model or an algorithm. The at least one processor 220 may estimate a first region (e.g., a first region 310 of FIG. 3) of the image including the defined object 330 and a second region (e.g., a second region 320 of FIG. 3) of the image distinct from the first region 310 based on the detection of the defined object 330. The at least one processor 220 may calibrate the image to enhance the first region 310 including the defined object 330. According to an embodiment of the disclosure, the at least one processor 220 may distinguish and identify at least one region (e.g., a sky region and/or a non-sky region) using an AI model. For example, the defined object 330 may be a cloud, but is not limited thereto. For example, calibration of an image may be performed by changing a luminance of the first region 310 to shift a luminance distribution range of the first region 310. For example, the calibration of the image may be performed by increasing a luminance deviation of the first region 310. An operation in which the at least one processor 220 provides a calibrated image by enhancing the first region 310 will be described later with reference to FIG. 4.

According to an embodiment of the disclosure, the at least one processor 220 may include an object detection unit 221 for detecting the defined object 330 included in the image, a region information extraction unit 222 for extracting the first region 310 and the second region 320, and/or an image enhancement unit for providing a calibrated image by enhancing the first region 310. According to an embodiment of the disclosure, the object detection unit 221, the region information extraction unit 222, and/or the image enhancement unit 223 may be, as a set of stored instructions or as codes, instructions/codes that are at least temporarily resided in the at least one processor 220, or a storage space storing instructions/codes, or may be a part of circuitry constituting the at least one processor 220. According to an embodiment of the disclosure, at least one of the object detection unit 221, the region information extraction unit 222, and/or the image enhancement unit 223 may be configured with a separate image processing processor logically divided in the at least one processor 220 or physically separated from the at least one processor 220.

According to an embodiment of the disclosure, the display 230 may be configured to display visual information. For example, the display 230 may be configured to display an image and/or a visual object based on control of the at least one processor 220. The at least one processor 220 may control the display driver integrated (DDI) circuit such that the image and/or the visual object is displayed on the display 230. For example, image data may include at least one pixel-specific information (e.g., a color and/or a luminance). As at least one pixel is driven based on a voltage value or a current value, visual information corresponding to the image data may be displayed on the display 230.

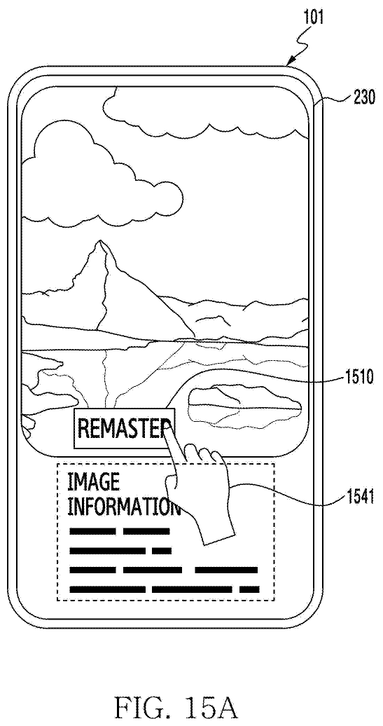

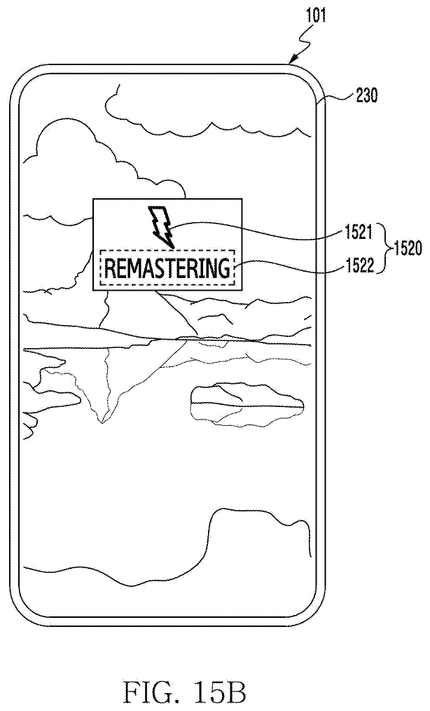

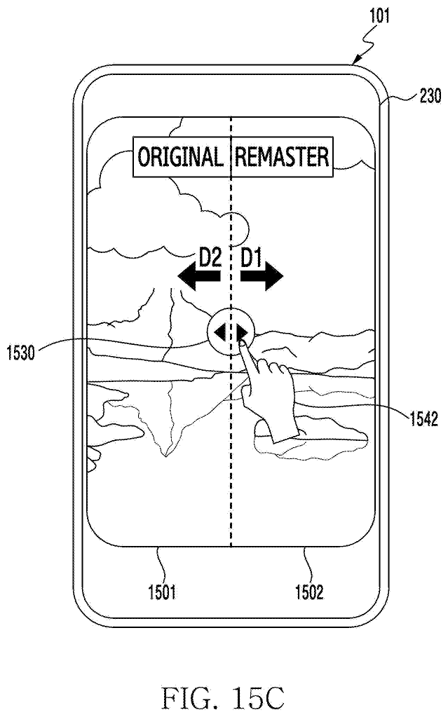

According to an embodiment of the disclosure, the display 230 may display an original image before calibration and/or a calibrated image after calibration. For example, the display 230 may display a calibrated image in which saturation, brightness, and/or color of the image are changed according to processing of the image enhancement unit 223. According to an embodiment of the disclosure, the display 230 may display at least one visual object (e.g., a user interface) for receiving a user input. The original image, the calibrated image, and the at least one visual object displayed on the display 230 will be described later with reference to FIG. 15C.

According to an embodiment of the disclosure, the camera 240 may generate an image by capturing a subject. For example, the camera 240 may include components, such as a lens that collects light emitted from the subject, and an image sensor for converting the light collected through the lens into an electrical signal. The image captured through the camera 240 may be stored in the memory 210.

According to an embodiment of the disclosure, the at least one processor 220 may generate a calibrated image by enhancing or improving at least a portion of the original image by using an artificial intelligence model. For example, image processing using the artificial intelligence model may be performed based on machine learning and deep learning algorithms. The artificial intelligence model may improve a quality of the image by learning a manner in which a computer understands and analyzes an image and identifying characteristics and patterns of the image. An image processing technology using a result of the learning may provide a calibrated image by improving details in the image, removing noise, and optimizing color and luminance. The electronic device 101 may provide a user with an image calibrated through the image processing. For example, in a case that the user captures a landscape using the camera 240, a sky region included in the landscape may have a relatively narrow range of luminance distribution. Since a boundary of a cloud is not clearly distinguished when the cloud is included in the sky region, an image having a feeling different from an actual landscape may be generated. In order to enhance the sky region, in a case that an red, green and blue (RGB) value of at least one pixel included in the sky region is simply calibrated to a defined (or pre-determined) RGB value, it may be difficult to generate a high-quality image even when the original image is calibrated.

The electronic device 101 according to an embodiment of the disclosure may provide a calibrated image by distinguishing the first region 310 and the second region 320 of the image including the defined object 330 based on the detection of the defined object 330 included in the image, and enhancing the first region 310. The electronic device 101 may improve a user experience by providing a calibrated image similar to a real landscape by enhancing the original image using the image processing technology. Hereinafter, the electronic device 101 for providing a calibrated image through the image processing technology will be described.

FIG. 3 illustrates an image according to an embodiment of the disclosure.

Referring to FIG. 3, an image 300 may be an example of at least one image stored in memory (e.g., the memory 210 of FIG. 2). The image 300 may be an image captured through a camera (e.g., the camera 240 of FIG. 2) or an image obtained from an external electronic device.

Referring to FIG. 3, the image 300 may be an image obtained by capturing a landscape. For example, various objects 341, 342, 343, 344, and 330 may be included in the image 300. The various objects 341, 342, 343, 344, and 330 may include an object, such as a tree 341, a lawn 342, a road 343, a building 344, and a cloud (e.g., the object 330), but are not limited thereto.

According to an embodiment of the disclosure, the image 300 may include a plurality of regions. For example, based on a type, a characteristic, or a setting of at least one object, the plurality of regions may be distinguished into a plurality of regions, such as a first region, a second region, and/or a third region. In an example to be described later, it is described that a first region 310 and a second region 320 are included in the image 300, but are not limited thereto. For example, the image 300 may also include three or more regions.

According to an embodiment of the disclosure, the image 300 may include the first region 310 and the second region 320. The first region 310 may be referred to as a portion of the image 300 including the defined object 330. For example, the defined object 330 may be a cloud. For example, the first region 310 may be a sky region including the cloud. However, it is not limited thereto. For example, the defined object 330 may be a tree, and the first region 310 may also be a lawn region including the tree. The second region 320 may be referred to as another portion of the image 300 distinct from the first region 310. For example, the second region 320 may be a ground region distinct from the sky region. The ground region may be a region including an object, such as the tree 341, the lawn 342, the road 343, and the building 344. In the disclosure, as an example of the first region 310, the second region 320, and the defined object 330, the first region 310 may be referred to as a sky region, the second region 320 may be referred to as a non-sky region, and the defined object 330 may be referred to as a cloud. In the disclosure, the first region 310 may be referred as a sky region, the second region 320 may be referred as a non-sky region, and the defined object 330 may be referred as a cloud, but these are merely examples for convenience of description and are not limited thereto.

According to an embodiment of the disclosure, in a case that the image 300 is an image captured during the daytime, a luminance of pixels included in the sky region of the image 300 may appear to be high due to sunlight. Since the cloud is positioned in the sky region, a boundary of the cloud may be difficult to appear clearly. In a case that the luminance of pixels included in the sky region appears to be high, and the boundary of the cloud does not appear clearly, a quality of the image 300 obtained by capturing the landscape may be deteriorated. For example, as the luminance of pixels included in the sky region appears to be high, a clear sky may be difficult to be represented, and a contrast between the cloud and the sky region may be difficult to be represented. The deterioration may cause a difference between a real landscape and a landscape displayed by the image 300.

An electronic device (e.g., the electronic device 101 of FIG. 2) according to an embodiment may calibrate the image 300 by extracting the sky region and the non-sky region in the image 300 and adjusting a luminance and a color of first pixels included in the sky region. Since the luminance and the color of the sky region are enhanced in the calibrated image, a clear sky region may be represented.

FIG. 4 is a flow chart illustrating an operation of calibrating an image by an electronic device according to an embodiment according to an embodiment of the disclosure.

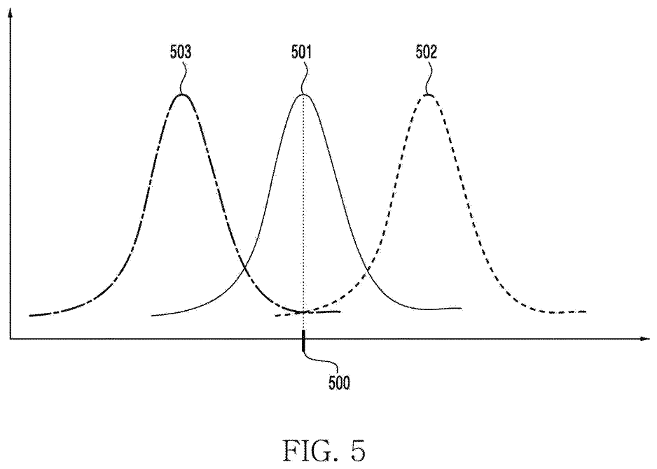

FIG. 5 illustrates a histogram obtained from an image according to an embodiment of the disclosure.

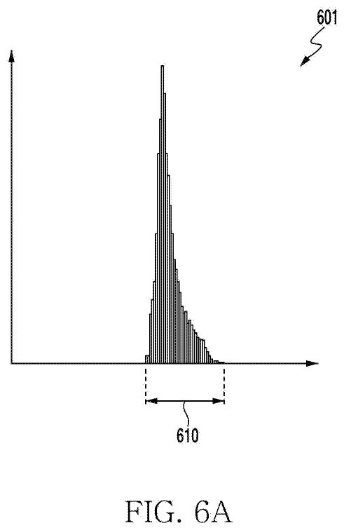

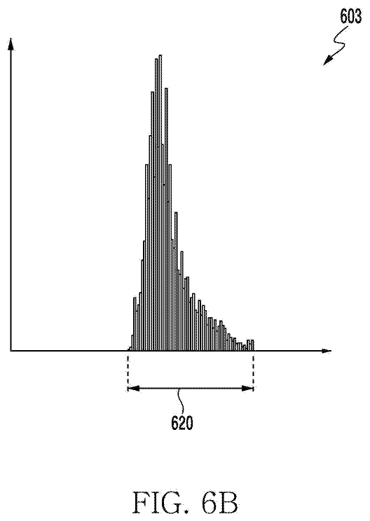

FIG. 6A illustrates a histogram for a first region of an original image according to an embodiment of the disclosure.

FIG. 6B illustrates a histogram for a first region of a calibrated image according to an embodiment of the disclosure.

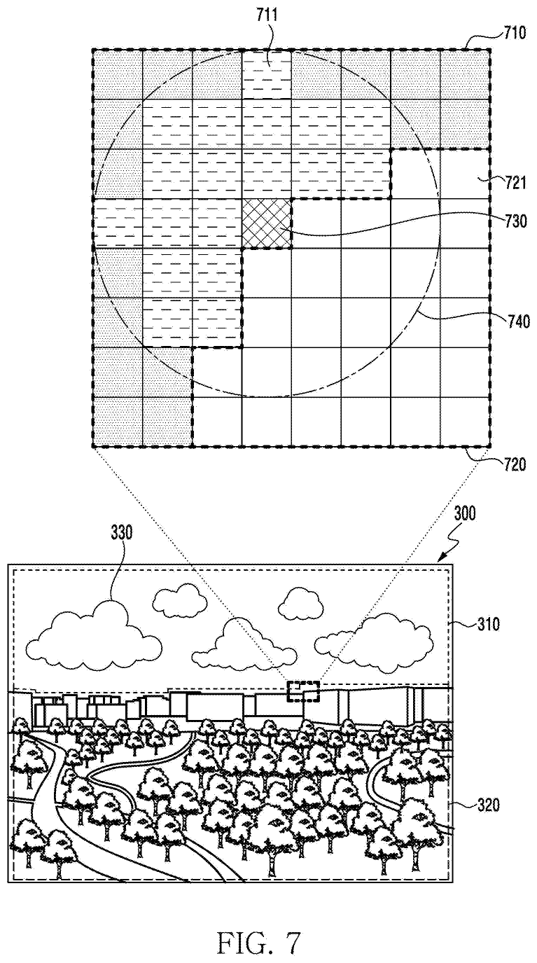

FIG. 7 illustrates calibrating an image based on a weighted sum according to an embodiment of the disclosure.

Operations described in FIG. 4 may be operations performed by an electronic device (e.g., the electronic device 101 of FIG. 2) when instructions stored in memory (e.g., the memory 210 of FIG. 2) are executed individually or collectively by at least one processor (e.g., the at least one processor 220 of FIG. 2).

Referring to FIG. 4, in operation 401, instructions, when executed individually or collectively by the at least one processor 220, may cause the electronic device 101 to estimate a first region (e.g., the first region 310 of FIG. 3) including a defined object (e.g., the defined object 330 of FIG. 3) and a second region (e.g., the second region 320 of FIG. 3) distinct from the first region from an image (e.g., the image 300 of FIG. 3).

According to an embodiment of the disclosure, the at least one processor 220 may obtain an image stored in memory 210. The at least one processor 220 may estimate the first region 310 and the second region 320 in the image based on a user input requesting generation of a calibrated image for the obtained original image. For example, the at least one processor 220 may use a first artificial intelligence model to distinguish the first region 310 and the second region 320. For example, the first artificial intelligence model may be an artificial intelligence model trained to distinguish the first region 310 and the second region 320 based on detection of the defined object 330 included in the first region 310, but is not limited thereto. For example, the first artificial intelligence model may also be an artificial intelligence model trained to distinguish the first region 310 and the second region 320 based on a difference between a color of the first region 310 and a color of the second region 320.

According to an embodiment of the disclosure, the estimation of the first region 310 and the second region 320 may be referred to as classifying all pixels included in the image into a class corresponding to the first region 310 and a class corresponding to the second region 320. For example, the at least one processor 220 may allocate a first label corresponding to the first region 310 or a second label corresponding to the second region 320 to each of all pixels included in the image. The first label may be allocated to first pixels included in the first region 310, and the second label may be allocated to second pixels included in the second region 320.

In operation 403, the instructions, when executed individually or collectively by the at least one processor 220, may cause the electronic device 101 to change a first luminance of the first pixels to a second luminance, to shift a luminance distribution range of the first pixels included in the first region 310 based on a reference luminance (e.g., a reference luminance 500 of FIG. 5).

According to an embodiment of the disclosure, the first region 310 may be referred to as a sky region, and the second region 320 may be referred to as a non-sky region distinct from the sky region. In a case of an image captured during the daytime when the sun is present in the sky region, the sky region may appear relatively bright, and in a case of an image captured during the nighttime when the sun is low, the sky region may appear relatively dark. In a case that the sky region appears relatively bright, the non-sky region may appear relatively bright, and in a case that the sky region appears relatively dark, the non-sky region may appear relatively bright. An impression and an atmosphere of the image may be distorted by a contrast effect between the luminance of the first pixels included in the sky region and the luminance of the second pixels included in the non-sky region. The at least one processor 220 may adjust the luminance of the first pixels by shifting the luminance distribution range of the first pixels based on the reference luminance 500. For example, the at least one processor 220 may change a first luminance of pixels to a second luminance. Changing the luminance of pixels may cause substantially the same effect as a change in an exposure value of a camera (e.g., the camera 240 of FIG. 1).

According to an embodiment of the disclosure, the at least one processor 220 may obtain a histogram of the luminance of the first pixels estimated to be the first region 310. The histogram that represents a luminance distribution of an image as a graph may be represented by the number of pixels according to a luminance value. Referring to FIG. 5, a horizontal axis of the histogram indicates a luminance value, and a vertical axis of the histogram indicates the number of pixels.

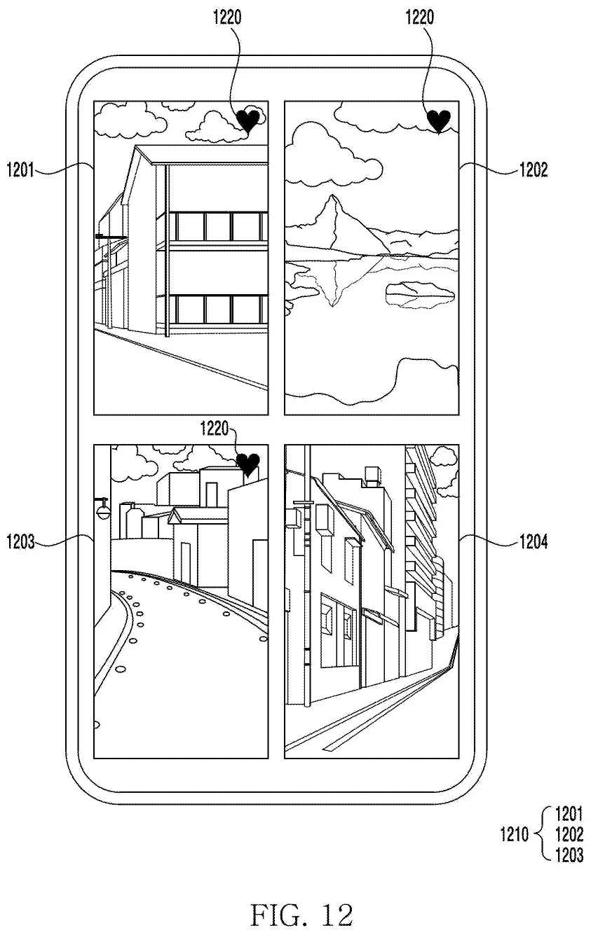

According to an embodiment of the disclosure, the reference luminance 500 may be determined in advance. The reference luminance 500 may be determined based on a luminance distribution of first pixels included in a sky region in an image when a sky exhibiting an ideal brightness is captured. The sky exhibiting the ideal brightness may be referred to as a sky having a brightness that is not too bright or not too dark compared to brightness of at least one object included in the image and is similar thereto. For example, a first graph 501 of FIG. 5 may be a graph indicating a distribution of a histogram of the first pixels for a sky region that is not too bright or too dark compared to a non-sky region. The reference luminance 500 may be a default value. For example, the reference luminance 500, which is a representative value of a first graph, may be one of a mean, a median, a mode, or an expected value for the luminance distribution indicated by the first graph 501, but is not limited thereto. According to an embodiment of the disclosure, the reference luminance 500 may also be determined based on at least one favorite image. Descriptions of the at least one favorite image will be described later with reference to FIG. 12. According to an embodiment of the disclosure, the reference luminance 500 may be used to determine whether the luminance of the first pixels is bright or dark. For example, by comparing a value (a total bin point) obtained by adding a bin start point (e.g., cumulative 0.03%) and a bin end point (e.g., cumulative 99.7%) of the first pixels with the reference luminance 500, it may be determined whether it is brighter or darker than the reference luminance 500. For example, in a case that the total bin point is greater than the reference luminance 500, the luminance of the first pixels may be determined to be bright, and in a case that the total bin point is less than the reference luminance 500, the luminance of the first pixels may be determined to be dark.

A second graph 502 of FIG. 5 may be a graph having a brighter luminance distribution range than the first graph 501. For example, in a case of an image obtained by capturing a sky having a brighter brightness than the ideal brightness, a luminance distribution range of first pixels included in a sky region may have the same luminance distribution range as in the second graph 502. For example, a representative value of the second graph 502 may have a higher luminance value than the reference luminance 500. According to an embodiment of the disclosure, the at least one processor 220 may shift the luminance distribution range of the first pixels based on the reference luminance 500. For example, the at least one processor 220 may lower the luminance of the first pixels such that the representative value of the second graph 502 approaches the reference luminance 500. As the luminance of the first pixels decreases, the second graph 502 may shift to be closer to the first graph 501 having the reference luminance 500. As the second graph 502 shifts closer to the first graph 501, a sky region having too high luminance may be changed to have an ideal luminance or a luminance similar to the ideal luminance.

A third graph 503 of FIG. 5 may be a graph having a darker luminance distribution range than the first graph 501. For example, in a case of an image obtained by capturing a sky having a darker brightness than the ideal brightness, a luminance distribution range of first pixels included in a sky region may have the same luminance distribution range as in the third graph 503. For example, a representative value of the third graph 503 may have a lower luminance value than the reference luminance 500. According to an embodiment of the disclosure, the at least one processor 220 may shift the luminance distribution range of the first pixels based on the reference luminance 500. For example, the at least one processor 220 may increase the luminance of the first pixels such that the representative value of the third graph 503 approaches the reference luminance 500. As the luminance of the first pixels increases, the third graph 503 may shift to be closer to the first graph 501 having the reference luminance 500. As the third graph 503 shifts closer to the first graph 501, a sky region having too low luminance may be changed to have an ideal luminance or a luminance similar to the ideal luminance.

According to an embodiment of the disclosure, the at least one processor 220 may set a maximum calibration value (e.g., a first maximum calibration value) of the luminance to be changed from the first luminance when shifting the luminance distribution range of the first pixels. In order to reduce overcalibration due to excessive shift, the movement of the luminance distribution range may be limited by the first maximum calibration value. For example, an example of a pseudo code for changing the luminance of the first pixels may be referred to in Table 1 below.

```
TABLE 1
total_bin_point = bin_start_point_of_sky_y_histogram +
bin_end_point_of_sky_y_histogram
MAX_CHANGED_EXPOSURE = 40
# Case: When sky is more of a dark side
if total_bin_point < cloudnine_target_luminance_level:
  changed_exposure_val = calc_expsoure_to_bright( )
  if changed_exposure_val > MAX_CHANGED_EXPOSURE:
changed_exposure_val = MAX_CHANGED_EXPOSURE
# Case: When sky is more of a bright side
else:
  changed_exposure_val = calc_exposure_to_dark( )
  if abs(changed_exposure_val) > MAX_CHANGED_EXPOSURE:
    changed_exposure_val = MAX_CHANGED_EXPOSURE
exposure_shift(changed_exposure_val)
```

Referring to the Table 1, a change in an exposure value may cause a change in a luminance value. The MAX_CHANGED_EXPOSURE may be referred to as a maximum calibration value (e.g., a first maximum calibration value) of the luminance to be changed. Referring to the Table 1, the first maximum calibration value is illustrated as 40, but is not limited thereto. For example, in a case that a total bin point is greater or less than the reference luminance 500, the luminance distribution of the first pixels may shift within a limit of 40. The pseudo code is merely an example and is not limited thereto.

Referring back to FIG. 4, in operation 405, the instructions, when executed individually or collectively by the at least one processor 220, may cause the electronic device 101 to change a first color of at least one pixel among the first pixels to a second color such that a luminance deviation of the first pixels increases.

A graph 601 illustrated in FIG. 6A indicates a histogram of the first region 310 of the original image before calibration. Referring to FIG. 6A, the histogram of the first pixels included in the sky region in the original image may be concentrated in a certain range. Since colors represented in the sky region are limited, the luminance distribution range of the first pixels included in the sky region may be narrow. For example, although objects capable of being found in the sky may include objects, such as an airplane, a satellite, and a bird, an object other than objects, such as the sun, a cloud, and the moon is difficult to appear, and thus it may be difficult for the sky region to have another color other than a color corresponding to the cloud and a color corresponding to the sky. For example, for a range of 256 luminance values from 0 to 255, the luminance distribution range of the first pixels may be concentrated in a relatively narrow first range 610. Since the luminance distribution range of the first pixels is concentrated in the first range 610, it may be difficult for the sky region to appear clearly as a contrast between the cloud and the sky does not appear effectively in the original image.

According to an embodiment of the disclosure, the at least one processor 220 may change a first color of at least one pixel among the first pixels to a second color such that the luminance deviation of the first pixels increases. The first color may be referred to as a color of a pixel in an original image, and the second color may be referred to as a color of a pixel in a calibrated image. For example, the at least one processor 220 may expand a distribution of the first pixels by histogram stretching the first pixels. For example, the at least one processor 220 may change a color of the first pixels by scaling an RGB channel value.

A graph 603 illustrated in FIG. 6B indicates a histogram of the first region 310 of the calibrated image. Referring to FIG. 6B, the luminance distribution range of the first pixels concentrated in the relatively narrow first range 610 in the original image may be stretched to a relatively wide second range 620. For example, the at least one processor 220 may increase the luminance deviation of the first pixels through histogram stretching or RGB channel value scaling of the first pixels. Since the distribution range of the first pixels may increase as the luminance deviation increases, as the contrast between the cloud and the sky appears clearly in the calibrated image, the sky region may appear clearly.

Referring back to FIG. 4, in operation 407, the instructions, when executed individually or collectively by the at least one processor 220, may cause the electronic device 101 to change a color of at least one pixel among the first pixels to a third color based on a weighted sum of the first color and the second color.

According to an embodiment of the disclosure, the at least one processor 220 may change a color of at least a portion of the first pixels based on a weighted sum of the first color and the second color. For example, a luminance and a color of at least a portion of the first pixels included in the sky region may change according to a performance of the operation 403 and the operation 405. The first luminance of the first pixels may be changed to the second luminance. The first color of at least one pixel among the first pixels may be changed to the second color. Since the pixels changed by the performance of the operation 403 and the operation 405 may be first pixels, even when the operation 403 and the operation 405 are performed, a luminance and a color of the second pixels included in the non-sky region may be maintained. Since the luminance and the color of the second pixels are maintained, the luminance and the color of the second pixels in the original image may be substantially the same as the luminance and the color of the second pixels in the calibrated image. The luminance and the color of the first pixels disposed on a boundary between the first region 310 and the second region 320 may have a large difference from the luminance and the color of the second pixels. In a case that the luminance and the color of the first pixels disposed on the boundary are rapidly changed, the image may be unnatural and awkward due to the difference.

According to an embodiment of the disclosure, at least one pixel of the first pixels may be changed to a third color based on a weighted sum of the first color and the second color. FIG. 7 illustrates an example in which a weighted sum is applied to at least one pixel of first pixels 710 in contact with second pixels 720. For example, the at least one pixel changed to the third color may be referred to as a pixel in contact with the second pixels 720 among the first pixels 710. In FIG. 7, the at least one pixel changed to the third color based on the weighted sum is illustrated as a pixel disposed on the boundary between the first region 310 and the second region 320, but is not limited thereto. For example, the at least one processor 220 may also change a color of each of the first pixels 710 based on the weighted sum.

Referring to FIG. 7, among the first pixels 710, a color of a third pixel 730 may be changed to a third color based on a weighted sum of the first color and the second color. A weight of the weighted sum may be determined based on a ratio of the number of first pixels 710 to the number of pixels included in a defined range 740 from the at least one pixel changed to the third color. For example, assuming that the defined range 740 is a virtual circle having a radius including three pixels around the third pixel 730, 29 pixels may be included in the virtual circle. Among the 29 pixels included in the defined range 740, the number of first pixels 711 included in the sky region corresponding to the first region 310 may be 19, and the number of second pixels 721 included in the non-sky region corresponding to the second region 320 may be 10. Since the second pixels 721 have the first color, which is a color in the original image, a first weight corresponding to the first color may be calculated as 0.345 (=10/29) according to the number of the second pixels 721. Since the first pixels 711 have been changed from the first color to the second color according to the performance of the operation 405, a second weight corresponding to the second color may be calculated as 0.655 (=19/29) according to the number of the first pixels 711. In an example illustrated in FIG. 7, the at least one processor 220 may determine the third color of the third pixel 730 based on the following Equation 1.

$$pixel a = 0.655 * ( streteched pixel ) + ( origin pixel * ( 1 - 0.655 ) ) \qquad Equation 1$$

$$( pixel a : Third color , stretched pixel : Second color , origin pixel : \\ First color )$$

According to an embodiment of the disclosure, in a case that the weighted sum according to the weight is applied, as the number of the first pixels 711 included in the defined range 740 increases, the third color may be closer to a pixel value (e.g., the second color) of the calibrated image, and as the number of the second pixels 721 included in the defined range 740 increases, the third color may be closer to a pixel value (e.g., the first color) of the original image. In a case that the weighted sum of the first color and the second color is applied to the entire first pixels 710, the color of the third pixel 730 may be determined as a third color closer to the second color as it is spaced apart from the boundary between the first region 310 and the second region 320 toward the inside of the first region 310. For example, in a case that only the first pixels 711 are included in the defined range 740 from the third pixel 730, the third color may be substantially the same as the second color. By being disposed on the boundary, in a case of the third pixel 730 in contact with the second pixels 720, the third pixel 730 may be changed to a third color close to the first color. In a case that the weighted sum is applied to the entire first pixels 710, a natural final image may be generated as a change in the color of the first pixels 710 is gradually performed.

The electronic device 101 according to an embodiment of the disclosure may provide a calibrated image by enhancing the first region 310 in the original image. The first region 310 in the calibrated image may have a luminance distribution range close to the ideal luminance distribution range of the first region 310 by shifting the luminance distribution range close to the reference luminance. The first region 310 in the calibrated image may represent the first region 310 by having a histogram with the increased luminance deviation. As the first region 310 in the calibrated image is naturally connected at the boundary in contact with the second region 320, it may reduce unnaturalness due to the calibration and provide a natural impression. The electronic device 101 according to an embodiment may provide an improved user experience by providing the calibrated image including the enhanced first region 310.

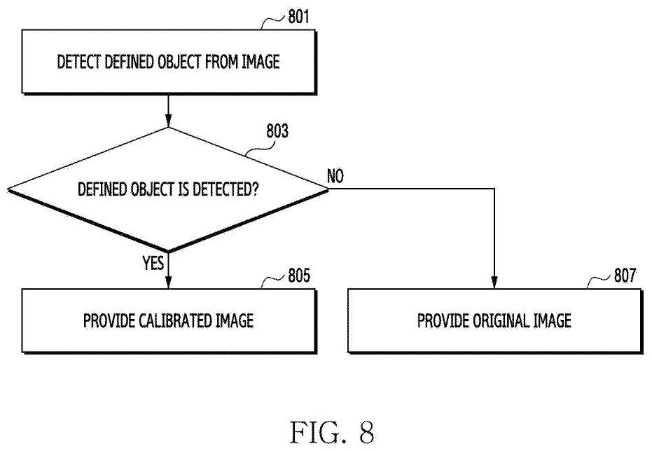

FIG. 8 is a flow chart illustrating an operation of determining whether to calibrate an image based on detection of a defined object by an electronic device according to an embodiment of the disclosure.

Operations described in FIG. 8 may be operations performed by an electronic device (e.g., the electronic device 101 of FIG. 2) when instructions stored in memory (e.g., the memory 210 of FIG. 2) are executed individually or collectively by at least one processor (e.g., the at least one processor 220 of FIG. 2).

Referring to FIG. 8, in operation 801, the instructions, when executed individually or collectively by the at least one processor 220, may cause the electronic device 101 to detect a defined object (e.g., the defined object 330 of FIG. 3) from an image.

According to an embodiment of the disclosure, the at least one processor 220 may be configured to detect the defined object 330 in an image by using a second artificial intelligence model. For example, the defined object 330 may be referred to as an object for estimating a first region (e.g., the first region 310 of FIG. 3). For example, in a case that the first region 310 is a sky region, the defined object 330 may be a cloud, but is not limited thereto.

According to an embodiment of the disclosure, the at least one processor 220 may use the second artificial intelligence model to detect the defined object 330. For example, the second artificial intelligence model may be an artificial intelligence model trained to detect the defined object 330. The second artificial intelligence model may be substantially the same as a first artificial intelligence model, which is for distinguishing the first region 310 and a second region (e.g., the second region 320 of FIG. 3), or may also be implemented as a portion of the first artificial intelligence model, but is not limited thereto.

In operation 803, the instructions, when executed individually or collectively by the at least one processor 220, may cause the electronic device 101 to identify whether an object is detected.

According to an embodiment of the disclosure, the at least one processor 220 may be configured to identify whether the defined object 330 has been detected in the image and perform calibration of an original image based on whether it is identified. For example, a calibrated image in which the first region 310 is enhanced may be provided in a case that the defined object 330 exists in the first region 310. The at least one processor 220 may perform the operations described in FIG. 4 in a case that the defined object 330 exists, and may not perform the operations illustrated in FIG. 4 in a case that the defined object 330 does not exist. For example, since a contrast by the defined object 330 is unnecessary when the defined object 330 does not exist in the first region 310, the at least one processor 220 may not perform enhancement operations for the first region 310. For example, since the first region 310 may be represented unclearly when the defined object 330 exists in the first region 310, the at least one processor 220 may perform enhancement operations for the first region 310.

According to an embodiment of the disclosure, in addition to a case that the defined object 330 exists, whether to detect the defined object 330 may be determined based on whether the defined object 330 exists in the image in a certain ratio or more. Even when the defined object 330 exists in the image, in a case that a ratio of an area of the first region 310 occupied by the defined object 330 is less than a defined ratio, it may be substantially the same as that the defined object 330 does not exist. For example, the at least one processor 220 may be configured to detect the defined object 330 based on identifying that a ratio of an area of the defined object 330 to an area of the first region 310 is greater than or equal to a defined ratio, by using the second artificial intelligence model. For example, the at least one processor 220 may determine that the defined object 330 exists based on identifying that a ratio of an area occupied by a cloud to an area of the sky region in the image is greater than or equal to a defined ratio (e.g., approximately 5%). In the operation 803, in a case that the defined object 330 is detected, operation 805 may be performed. In the operation 803, in a case that the defined object 330 is not detected, operation 807 may be performed.

In the operation 805, the instructions, when executed individually or collectively by the at least one processor 220, may cause the electronic device 101 to provide a calibrated image.

According to an embodiment of the disclosure, the at least one processor 220 may provide a calibrated image in which the first region 310 is enhanced based on the detection of the defined object 330. For example, in a case that the defined object 330 exists in the image, or in a case that the ratio of the area of the defined object 330 to the area of the first region 310 is greater than or equal to the defined ratio, the at least one processor 220 may provide a calibrated image by performing the operations described in FIG. 4. As the calibrated image is provided, an image in which the first region 310 is enhanced may be provided.

In the operation 807, the instructions, when executed individually or collectively by the at least one processor 220, may cause the electronic device 101 to provide the original image.

According to an embodiment of the disclosure, the at least one processor 220 may provide the original image based on the defined object 330 not being detected. Providing the original image may be referred to as the at least one processor 220 not calibrating the original image. For example, in a case that the defined object 330 does not exist in the image, or in a case that the ratio of the area of the defined object 330 to the area of the first region 310 is less than the defined ratio, the at least one processor 220 may not perform the operations described in FIG. 4.

According to an embodiment of the disclosure, since the enhancement of the first region 310 is for effectively contrasting the defined object 330 and the first region 310, it may be configured to calibrate the original image based on the detection of the defined object 330. For example, in a case that a cloud exists in the sky region, or the cloud exists more than a certain amount, the electronic device 101 may provide a clear image by enhancing a contrast between the sky and the cloud. Descriptions of the sky and the cloud are merely an example, and the disclosure is not limited thereto. For example, in a case that the image includes a flower in a lawn, a building disposed on a street, or a food including a plurality of ingredients, a calibrated image may be provided.

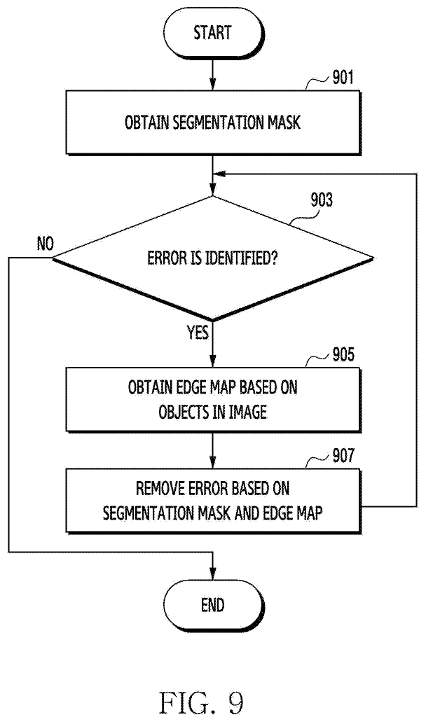

FIG. 9 is a flow chart illustrating an operation of calibrating a first region of an electronic device according to an embodiment of the disclosure.

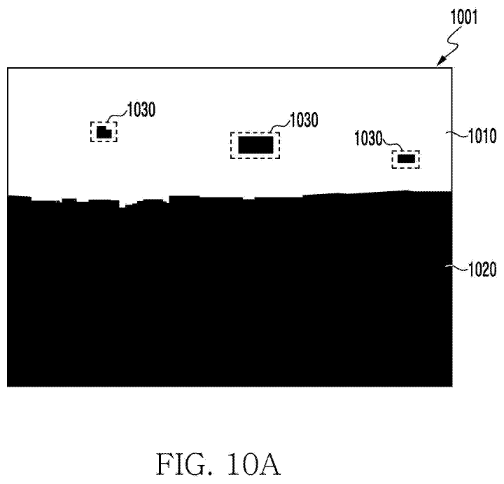

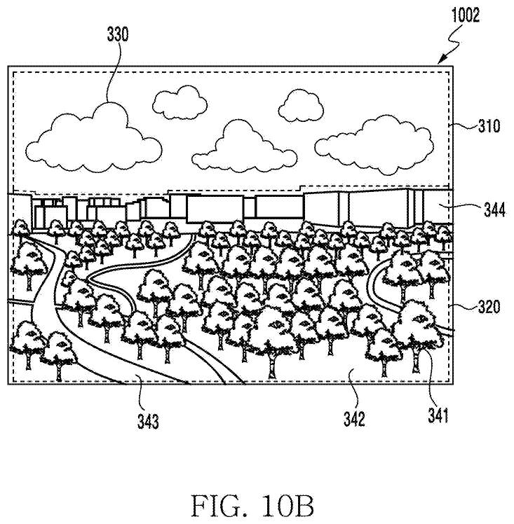

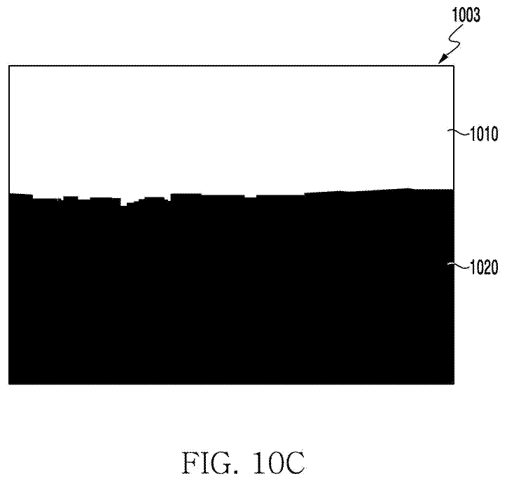

FIGS. 10A, 10B, and 10C illustrate processes in which an electronic device enhances a first region according to various embodiments of the disclosure.

Operations described in FIG. 9 may be operations performed by an electronic device (e.g., the electronic device 101 of FIG. 2) when instructions stored in memory (e.g., the memory 210 of FIG. 2) are executed individually or collectively by at least one processor (e.g., the at least one processor 220 of FIG. 2).

The operations described in FIG. 9 may be operations performed between the operation 401 and the operation 403 of FIG. 4. In a case that an error is identified in estimation of a first region (e.g., the first region 310 of FIG. 3) and a second region (e.g., the second region 320 of FIG. 3), the at least one processor 220 may calibrate the first region 310 and the second region 320 by removing the error. For example, an error may be caused as a label corresponding to a non-sky region is allocated to a pixel included in a sky region, or a label corresponding to the sky region is allocated to a pixel included in the non-sky region. By comparing a segmentation mask with an edge map to remove the error, the at least one processor 220 may calibrate the first region 310 and the second region 320 that have been estimated.

Referring to FIG. 9, in operation 901, the instructions, when executed individually or collectively by the at least one processor 220, may cause an electronic device 101 to obtain a segmentation mask according to the first region 310 and the second region 320.

According to an embodiment of the disclosure, the at least one processor 220 may obtain a segmentation mask (e.g., a segmentation mask 1001 of FIG. 10A) according to the first region 310 and the second region 320 by using a first artificial intelligence model. According to an embodiment of the disclosure, the at least one processor 220 may estimate the first region 310 and the second region 320 and obtain a segmentation mask according to the first region 310 and the second region 320. The at least one processor 220 may obtain a segmentation mask by allocating each of pixels included in an image to a label corresponding to the first region 310 or the second region 320.

FIG. 10A illustrates the segmentation mask 1001 generated for the image (e.g., the image 300 of FIG. 3) illustrated in FIG. 3. Referring to FIG. 10A, the at least one processor 220 may obtain the segmentation mask 1001 according to the estimation of the first region 310 and the second region 320. The at least one processor 220 may allocate a first label corresponding to the first region 310 or a second label corresponding to the second region 320 to each of all pixels in the image. As illustrated in FIG. 10A, in the segmentation mask 1001, pixels 1010 to which the first label is allocated may be displayed in a white color, and pixels 1020 to which the second label is allocated may be displayed in a black color.

Referring back to FIG. 9, in operation 903, the instructions, when executed individually or collectively by the at least one processor 220, may cause the electronic device 101 to identify an error for the first region 310 and the second region 320 that have been estimated.

According to an embodiment of the disclosure, the at least one processor 220 may be configured to identify an error for the first region 310 and the second region 320 that have been estimated. For example, an error for the first region 310 and the second region 320 estimated using the first artificial intelligence model may occur. As illustrated in FIG. 10A, since recognition of a partial region in the image is not properly performed, a hole region 1030 may be generated in the segmentation mask 1001. For example, as a portion divided into the non-sky region is generated in the sky region, the hole region 1030 may be generated. In a case of identifying the hole region 1030, the at least one processor 220 may be configured to identify an error. In the operation 903, in a case that an error is identified, operation 905 may be performed. In the operation 903, in a case that an error is not identified, since it is not necessary to calibrate the first region 310 and the second region 320 that have been estimated, the operation may be terminated.

In the operation 905, the instructions, when executed individually or collectively by the at least one processor 220, may cause the electronic device 101 to obtain an edge map (e.g., an edge map 1002 of FIG. 10B) based on objects in the image.

According to an embodiment of the disclosure, in order to remove the error, the at least one processor 220 may be configured to obtain an edge map indicating edge information in an image. FIG. 10B illustrates the edge map 1002 for the image illustrated in FIG. 3. Referring to FIG. 10B, the edge map 1002 may be generated by extracting edge information of objects 341, 342, 343, 344, and 330. For example, the at least one processor 220 may generate the edge map 1002 by identifying a portion where brightness or a color of an image changes rapidly. For example, the at least one processor 220 may extract edge information by differentiating a pixel value in an image, or may extract edge information by processing a pixel value in an image according to a specific criterion, but is not limited thereto. For example, the at least one processor 220 may also extract edge information using deep learning.

In the operation 907, the instructions, when executed individually or collectively by the at least one processor 220, may cause the electronic device 101 to remove the error, based on the segmentation mask and the edge map.

According to an embodiment of the disclosure, the at least one processor 220 may detect a region corresponding to the identified hole region 1030 in the edge map 1002 and an original image. By identifying an error for the hole region 1030 and removing the hole region 1030 when edge information is not detected for the hole region 1030, the at least one processor 220 may remove the error. FIG. 10C illustrates a segmentation mask 1003 in which the hole region 1030 of the segmentation mask 1001 illustrated in FIG. 10A is removed. Referring to FIG. 10C, the calibrated segmentation mask 1003 may be generated by removing the hole region 1030. For example, by changing the pixels 1010 to which the first label is allocated and/or the pixels 1020 to which the second label is allocated, the first region 310 and the second region 320 may be calibrated. The at least one processor 220 may perform the operation 903 again to identify whether an error exists with respect to the first region 310 and the second region 320 that have been calibrated. In a case that an error is not identified with respect to the calibrated segmentation mask 1003, the operation may be terminated. In a case that an error is identified with respect to the calibrated segmentation mask 1003, the operation 905 may be performed again.

The electronic device 101 according to an embodiment may accurately distinguish the first region 310 and the second region 320 by estimating the first region 310 and the second region 320 and then calibrating the first region 310 and the second region 320 that have been estimated by using the segmentation mask and the edge map. In a case that an error exists in the distinction between the first region 310 and the second region 320, even when the image is enhanced and calibrated, calibration on a region in which the error exists may be incorrectly performed. The at least one processor 220 may accurately enhance the first region 310 by calibrating the first region 310 and the second region 320 that have been estimated, before calibrating the original image.

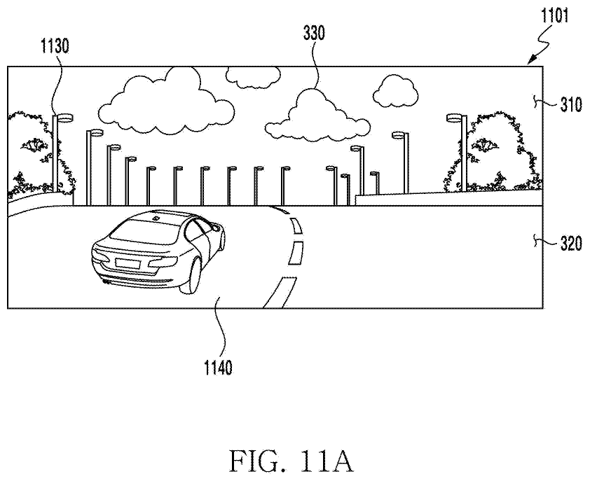

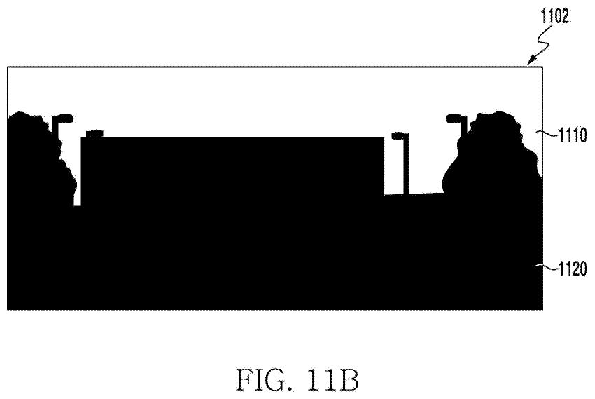

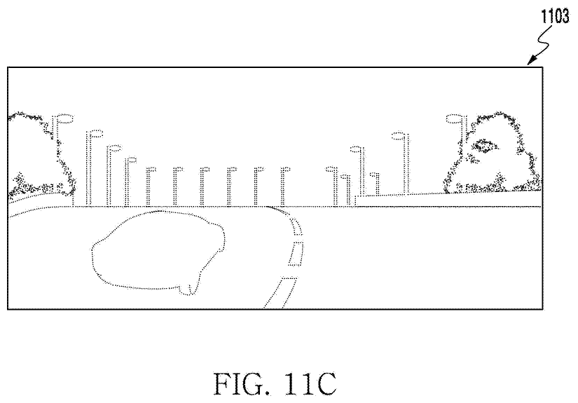

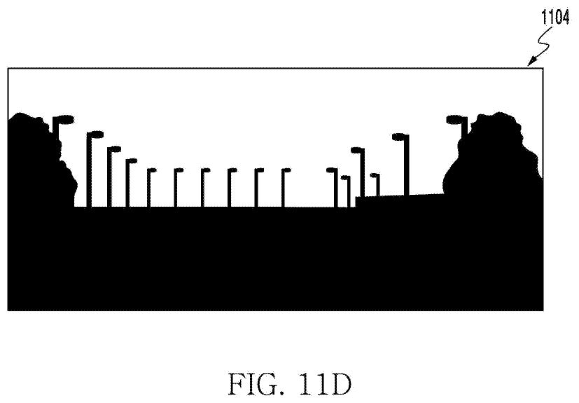

FIGS. 11A, 11B, 11C, and 11D illustrate processes in which an electronic device enhances a first region according to various embodiments of the disclosure.

According to an embodiment of the disclosure, in a case that a boundary between a first region 310 and a second region 320 is complexly formed, calibration for the first region 310 and the second region 320 may be required.

FIG. 11A illustrates an image stored in memory according to an embodiment of the disclosure.

Referring to FIG. 11A, an image 1101 may include the first region 310 and the second region 320. For example, the first region 310 may be referred to as a sky region, and the second region 320 may be referred to as a non-sky region. In a case that a plurality of objects exist on the boundary between the first region 310 and the second region 320, an error may be caused in distinction between the first region 310 and the second region 320.

FIG. 11B illustrates a segmentation mask for an image illustrated in FIG. 11A according to an embodiment of the disclosure.

Referring to FIG. 11B, pixels 1110 to which a first label is allocated may be displayed in a white color, and pixels 1120 to which a second label is allocated may be displayed in a black color. In a case that the plurality of objects have a shape extending to the first region 310, the first region 310 may be incorrectly estimated as the second region 320 due to the plurality of objects. For example, in a case that a plurality of streetlights (e.g., a plurality of streetlights 1130 of FIG. 11A) extending toward a sky are disposed along a road 1140, since the plurality of streetlights 1130 that are seen in the distance are overlappingly displayed the sky, an error in which the first region 310 is estimated as the second region 320 may occur. According to an embodiment of the disclosure, the at least one processor 220 may be configured to identify an error in an segmentation mask 1102.

FIG. 11C illustrates an edge map for an image illustrated in FIG. 11A according to an embodiment of the disclosure.

Referring to FIG. 11C, the at least one processor 220 may obtain an edge map by extracting edge information. For example, the at least one processor 220 may generate an edge map 1103 by extracting edge information of objects, such as a car, a streetlight, a road, and a street tree included in the image. The edge map 1103 may be generated based on edge information of objects included in the image. According to an embodiment of the disclosure, the at least one processor 220 may be configured to remove the error based on the segmentation mask 1102 and the edge map 1103. For example, the at least one processor 220 may remove the error by detecting the error by using the segmentation mask 1102 and the edge map 1103 and calibrating the segmentation mask 1102 by referring to a pixel value and edge information of an original image corresponding to a region where the error occurred.

FIG. 11D illustrates a segmentation mask in which an error of a segmentation mask illustrated in FIG. 11B is removed according to an embodiment of the disclosure.

Referring to FIG. 11D, a calibrated segmentation mask 1104 may be generated by removing the error. For example, the error may be removed by distinguishing pixels that have been incorrectly distinguished into the second region 320 by the plurality of streetlights 1130, into the first region 310. According to an embodiment of the disclosure, the at least one processor 220 may accurately extract the first region 310 by calibrating the first region 310 and the second region 320. As the first region 310 is accurately extracted, luminance and/or a color of first pixels included in the first region 310 may be changed, thereby providing a calibrated image in which the first region 310 is enhanced.

FIG. 12 illustrates an electronic device according to an embodiment displays favorite images according to an embodiment of the disclosure.

Referring to FIG. 12, an electronic device 101 according to an embodiment may distinguish at least one favorite image 1210 for at least one image stored in memory (e.g., the memory 210 of FIG. 2). For example, the electronic device 101 may receive a user input selected as the favorite image 1210 among images stored in the memory 210. The electronic device 101 may store information on the at least one favorite image 1210 selected as the favorite image 1210 by a user. For example, the user may set favorites for a preferred image among images stored in the memory 210, but is not limited thereto. For example, the electronic device 101 may be configured to display a visual object 1220 representing the at least one favorite image 1210 selected as the favorite image 1210.

According to an embodiment of the disclosure, at least one processor (e.g., the at least one processor 220 of FIG. 2) may be configured to generate a calibrated image based on the at least one favorite image 1210. For example, the at least one processor 220 may be configured to set a reference luminance (e.g., the reference luminance 500 of FIG. 5) based on a luminance distribution range of pixels included in a region corresponding to a first region (e.g., the first region 310 of FIG. 3) in the at least one favorite image 1210. For example, the at least one processor 220 may estimate information related to an average luminance distribution range for at least one histogram obtained from the at least one favorite image 1210 and set the reference luminance 500 based on the information. For example, a first image 1201, a second image 1202, a third image 1203, and a fourth image 1204 illustrated in FIG. 12 may be stored in the memory 210. Among the images, in a case that the first image 1201, the second image 1202, and the third image 1203 are selected as the at least one favorite image 1210 preferred by a user, the at least one processor 220 may obtain histograms for each of the first image 1201, the second image 1202, and the third image 1203. The at least one processor 220 may be configured to estimate information related to an average luminance distribution range of the histograms and set a representative value of the estimated average luminance distribution range as the reference luminance 500. As the reference luminance 500 is set based on the at least one favorite image 1210, when a luminance distribution range of first pixels is shifted, a calibrated image having a luminance distribution range similar to that of the at least one favorite image 1210 may be provided.

According to an embodiment of the disclosure, the at least one processor 220 may be configured to determine a second color based on a luminance deviation of pixels included in a region corresponding to the first region 310 in the at least one favorite image 1210. For example, the at least one processor 220 may determine the second color such that a deviation of a histogram for the first region 310 of the calibrated image corresponds to the luminance deviation of the pixels included in the region corresponding to the first region 310 in the at least one favorite image 1210.

For example, the at least one processor 220 may estimate information related to an average luminance deviation for at least one histogram obtained from the at least one favorite image 1210 and set a luminance deviation to be changed based on the information. For example, the at least one processor 220 may obtain histograms for each of the first image 1201, the second image 1202, and the third image 1203. The at least one processor 220 may estimate information related to an average luminance deviation of the histograms, and determine the second color such that a luminance deviation of the calibrated image corresponds to the estimated average luminance deviation. As the luminance deviation is set based on the at least one favorite image 1210, when a color of the first pixels is changed, a calibrated image having a luminance deviation similar to that of the at least one favorite image 1210 may be provided.

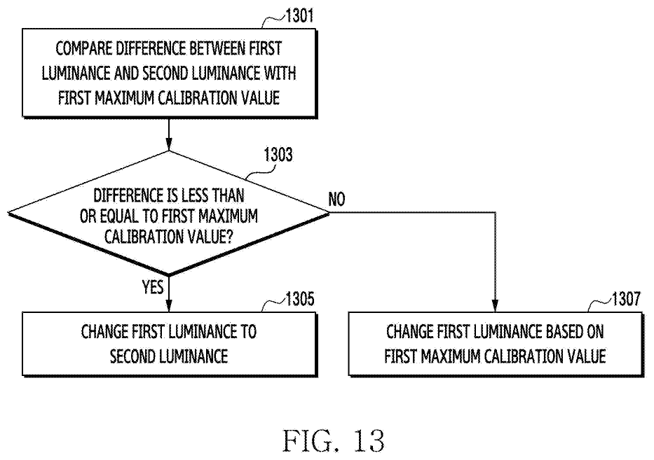

According to an embodiment of the disclosure, the at least one processor 220 may set a luminance to be changed from a first luminance based on the luminance distribution range of the pixels included in the region corresponding to the first region 310 in the at least one favorite image 1210. For example, the at least one processor 220 may set a maximum calibration value (e.g., a first maximum calibration value) of the luminance to be changed from the first luminance. Movement of the luminance distribution range may be limited by the first maximum calibration value. Operations of the electronic device 101 according to the first maximum calibration value will be described later with reference to FIG. 13.

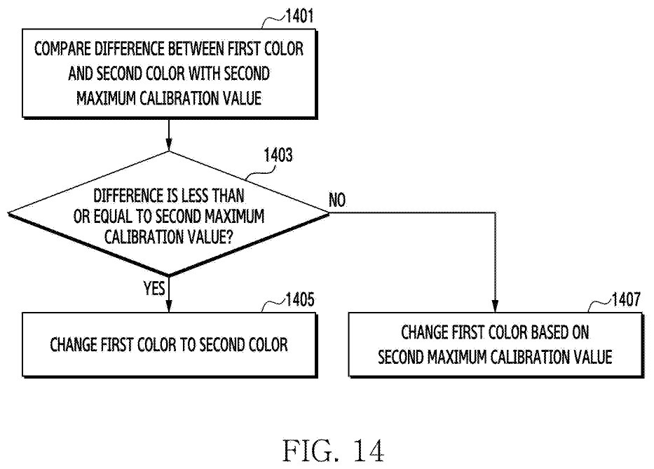

According to an embodiment of the disclosure, the at least one processor 220 may set a maximum calibration value (e.g., a second maximum calibration value) of a color to be changed from a first color based on the luminance deviation of the pixels included in the region corresponding to the first region 310 in the at least one favorite image 1210. Stretching of the luminance deviation may be limited by the second maximum calibration value. Operations of the electronic device 101 according to the second maximum calibration value will be described later with reference to FIG. 14.

According to an embodiment of the disclosure, the at least one favorite image 1210 may be an image directly selected by the user, but is not limited thereto. According to an embodiment of the disclosure, the at least one processor 220 may distinguish the at least one favorite image 1210 by using all or a portion of images stored in the memory 210. For example, the at least one processor 220 may also distinguish at least one image including a defined object 330 among images stored in the memory 210 into the at least one favorite image 1210. According to an embodiment of the disclosure, the at least one processor 220 may assign different weights to each of the images. For example, the at least one processor 220 may obtain information related to a luminance distribution range and/or a luminance deviation by assigning a relatively high weight to an image calibrated by the user and/or an image including the defined object 330, and assigning a relatively low weight to a remaining image.

FIG. 13 is a flow chart illustrating an operation in which an electronic device changes a luminance of first pixels according to an embodiment of the disclosure.

Operations described in FIG. 13 may be operations performed by an electronic device (e.g., the electronic device 101 of FIG. 2) when instructions stored in memory (e.g., the memory 210 of FIG. 2) are executed individually or collectively by at least one processor (e.g., the at least one processor 220 of FIG. 2).

The operations described in FIG. 13 may be referred to as the operations for the operation 403 of FIG. 4. According to an embodiment of the disclosure, when changing a first luminance of first pixels included in a first region (e.g., the first region 310 of FIG. 3), the at least one processor 220 may reduce overcalibration of an original image by changing the luminance based on a preset first maximum calibration value. The first maximum calibration value may be set based on at least one favorite image.

Referring to FIG. 13, in operation 1301, instructions, when executed individually or collectively by the at least one processor 220, may cause the electronic device 101 to compare a difference between a first luminance and a second luminance with the first maximum calibration value.

According to an embodiment of the disclosure, the first maximum calibration value may be determined in advance. According to an embodiment of the disclosure, the first maximum calibration value may be a value preset by a user, but is not limited thereto. According to an embodiment of the disclosure, the first maximum calibration value may be set based on at least one favorite image. For example, the at least one processor 220 may be configured to identify a luminance distribution range of pixels included in a region corresponding to the first region 310 in the at least one favorite image and set the first maximum calibration value based on the luminance distribution range. According to an embodiment of the disclosure, the at least one processor 220 may compare a difference between the first luminance of the first pixels in the original image and the second luminance according to a luminance distribution range of the first pixels shifted based on a reference luminance (e.g., the reference luminance 500 of FIG. 5) with the first maximum calibration value.

In operation 1303, the instructions, when executed individually or collectively by the at least one processor 220, may cause the electronic device 101 to identify whether the difference between the first luminance and the second luminance is less than or equal to the first maximum calibration value.

According to an embodiment of the disclosure, the at least one processor 220 may be configured to identify whether the difference is less than or equal to the first maximum calibration value or whether the difference exceeds the first maximum calibration value. For example, the at least one processor 220 may identify the second luminance of the first pixels to shift the luminance distribution range of the first pixels based on the reference luminance 500. The at least one processor 220 may determine whether a difference is less than or equal to the first maximum calibration value by comparing the difference between the second luminance to be changed and the first luminance in the original image with the first maximum calibration value. For example, in a case that the shift range of the first pixels is within the first maximum calibration value as the luminance of the first pixels is changed from the first luminance to the second luminance, the at least one processor 220 may be configured to identify the difference as less than or equal to the first maximum calibration value. In a case that the difference is less than or equal to the first maximum calibration value, operation 1305 may be performed. In a case that the difference exceeds the first maximum calibration value, operation 1307 may be performed.

In the operation 1305, the instructions, when executed individually or collectively by the at least one processor 220, may cause the electronic device 101 to change the first luminance of the first pixels to the second luminance.

According to an embodiment of the disclosure, the at least one processor 220 may be configured to change the first luminance to the second luminance based on identifying the difference less than or equal to the first maximum calibration value. In a case that the difference between the second luminance and the first luminance is less than or equal to the first maximum calibration value, even when the first luminance of the first pixels is changed to the second luminance, since the difference does not exceed the first maximum calibration value, the at least one processor 220 may change the first luminance to the second luminance. As the first luminance is changed to the second luminance, the luminance distribution range of the first pixels may be shifted to be close to the reference luminance 500. For example, by shifting a histogram of the luminance of the first pixels close to the reference luminance 500, the first region 310 may have an ideal luminance or a luminance similar to the ideal luminance.

In the operation 1307, the instructions, when executed individually or collectively by the at least one processor 220, may cause the electronic device 101 to change the first luminance of the first pixels based on the first maximum calibration value.

According to an embodiment of the disclosure, the at least one processor 220 may be configured to change the first luminance based on the first maximum calibration value based on identifying the difference exceeding the first maximum calibration value. In a case that the reference luminance 500 and the luminance distribution range of the first pixels are far away, as the first luminance is changed to the second luminance, the difference may exceed the first maximum calibration value. In a case that the luminance distribution range of the first pixels is shifted in a range exceeding the first maximum calibration value, the original image may be overcalibrated, such that the calibrated image may be unnatural. According to an embodiment of the disclosure, the at least one processor 220 may shift a histogram of the luminance of the first pixels so as to be closer to the reference luminance 500, within a first maximum calibration value. As the luminance distribution range of the first pixels is limitedly shifted by the first maximum calibration value, the first region may have a luminance similar to the ideal luminance. The electronic device 101 according to an embodiment may reduce overcalibration of the original image.

FIG. 14 is a flow chart illustrating an operation in which an electronic device changes a color of first pixels according to an embodiment of the disclosure.

Operations described in FIG. 14 may be operations performed by an electronic device (e.g., the electronic device 101 of FIG. 2) when instructions stored in memory (e.g., the memory 210 of FIG. 2) are executed individually or collectively by at least one processor (e.g., the at least one processor 220 of FIG. 2).

The operations described in FIG. 14 may be referred to as the operations for the operation 405 of FIG. 4. According to an embodiment of the disclosure, when changing a first color of first pixels included in a first region (e.g., the first region 310 of FIG. 3), the at least one processor 220 may reduce overcalibration of an original image by changing the color in consideration of a preset second maximum calibration value. The second maximum calibration value may be set based on at least one favorite image.

Referring to FIG. 14, in operation 1401, instructions, when executed individually or collectively by the at least one processor 220, may cause the electronic device 101 to compare a difference between a first color and a second color with the second maximum calibration value.

According to an embodiment of the disclosure, the second maximum calibration value may be determined in advance. According to an embodiment of the disclosure, the second maximum calibration value may be a value preset by a user, but is not limited thereto. According to an embodiment of the disclosure, the second maximum calibration value may be set based on at least one favorite image. For example, the at least one processor 220 may be configured to identify a luminance deviation of pixels included in a region corresponding to the first region 310 in the at least one favorite image and set the second maximum calibration value based on the luminance deviation. According to an embodiment of the disclosure, the at least one processor 220 may compare a difference between the first color of the first pixels in the original image and the second color of the first pixels according to histogram stretching with the second maximum calibration value.

In operation 1403, the instructions, when executed individually or collectively by the at least one processor 220, may cause the electronic device 101 to identify whether the difference between the first color and the second color is less than or equal to the second maximum calibration value.

According to an embodiment of the disclosure, the at least one processor 220 may be configured to identify whether the difference is less than or equal to the second maximum calibration value or whether the difference exceeds the second maximum calibration value. For example, the at least one processor 220 may identify the second color of the first pixels to increase the luminance deviation of the first pixels. The at least one processor 220 may determine whether a difference is less than or equal to the second maximum calibration value by comparing the difference between the second color to be changed and the first color in the original image with the second maximum calibration value. For example, when a histogram stretching range or a range in which an RGB channel value of the first pixels is scaled according to a color of the first pixels being changed from the first color to the second color is within the second maximum calibration value, the at least one processor 220 may be configured to identify the difference as less than or equal to the second maximum calibration value. In a case that the difference is less than or equal to the second maximum calibration value, operation 1405 may be performed. In a case that the difference exceeds the second maximum calibration value, operation 1407 may be performed.

In the operation 1405, the instructions, when executed individually or collectively by the at least one processor 220, may cause the electronic device 101 to change the first color of the first pixels to the second color.

According to an embodiment of the disclosure, the at least one processor 220 may be configured to change the first color to the second color based on identifying the difference less than or equal to the second maximum calibration value. In a case that the difference between the second color and the first color is less than or equal to the second maximum calibration value, even when the first color of the first pixels is changed to the second color, since the difference does not exceed the second maximum calibration value, the at least one processor 220 may change the first color to the second color. As the first color is changed to the second color, the luminance deviation of the first pixels may increase. For example, by increasing a range in which a histogram is distributed in the luminance of the first pixels from a relatively narrow first range (e.g., the first range 610 of FIG. 6A) to a relatively wide second range (e.g., the second range 620 of FIG. 6B), the first region 310 may effectively exhibit a contrast with respect to a defined object (e.g., the defined object 330 of FIG. 3). For example, as the luminance deviation of the first pixels included in a sky region increases a contrast between a cloud and a sky may appear effectively.

In the operation 1407, the instructions, when executed individually or collectively by the at least one processor 220, may cause the electronic device 101 to change the first color of the first pixels based on the second maximum calibration value.

According to an embodiment of the disclosure, the at least one processor 220 may be configured to change the first color based on the second maximum calibration value based on identifying the difference exceeding the second maximum calibration value. In a case that the difference between the second color to be changed and the first color before the change exceeds the second maximum calibration value, as the first color is changed to the second color, the original image may be overcalibrated, such that the calibrated image may be unnatural. According to an embodiment of the disclosure, the at least one processor 220 may change the color of the first pixels such that a histogram (or distribution range of the histogram) of the luminance of the first pixels increases within the second maximum calibration range. As the color of the first pixels is limitedly changed by the second maximum calibration value, the first region 310 may effectively exhibit a contrast with respect to the defined object 330. The electronic device 101 according to an embodiment may reduce overcalibration of the original image.

FIG. 15A illustrates a display displaying a first visual object according to an embodiment of the disclosure.

FIG. 15B illustrates a display displaying a second visual object according to an embodiment of the disclosure.

FIG. 15C illustrates a display displaying an original image and a calibrated image according to an embodiment of the disclosure.

Referring to FIG. 15A, an electronic device 101 according to an embodiment may include a display 230. The display 230 may be configured to display an image and at least one visual object.

The electronic device 101 according to an embodiment may be configured to display a first visual object 1510 for receiving a first user input 1541 on the display 230. The first user input 1541 may be the first user input 1541 for requesting generation of a calibrated image on the display 230. In a case that a user desires to obtain a calibrated image for an original image, the first user input 1541 may be provided through the first visual object 1510. For example, the first user input 1541 may be provided according to a touch input of the user to the first visual object 1510. At least one processor (e.g., the at least one processor 220 of FIG. 2) may generate a calibrated image based on receiving the first user input 1541 for the first visual object 1510. For example, the at least one processor 220 may be configured to generate a calibrated image by performing the operations described in FIG. 4 based on receiving the first user input 1541.

Referring to FIG. 15B, the electronic device 101 according to an embodiment may be configured to display a second visual object 1520 on the display 230. The second visual object 1520 may be a visual object for indicating that the original image is being calibrated. For example, the second visual object 1520 may include an icon 1521 indicating that it is being calibrated and/or a text 1522, such as “Remastering” but is not limited thereto. According to an embodiment of the disclosure, the at least one processor 220 may control the display 230 to display the second visual object 1520 while the image is being calibrated. The user may recognize that calibration of the image is in progress through the second visual object 1520.

Referring to FIG. 15C, the electronic device 101 according to an embodiment may be configured to display each of an original image 1501 and a calibrated image 1502 on the display 230. According to an embodiment of the disclosure, the at least one processor 220 may be configured to display each of the original image 1501 and the calibrated image 1502 on the display 230 based on generating the calibrated image 1502. For example, a portion of the image may be displayed as the original image 1501, and a remaining portion of the image may be displayed as the calibrated image 1502. For example, the at least one processor 220 may be configured to display a third visual object 1530 on the display 230 that may adjust a boundary between the original image 1501 and the calibrated image 1502. The user may adjust a ratio between an area of the original image 1501 and an area of the calibrated image 1502 by adjusting the boundary through the third visual object 1530. For example, in a case that a drag input 1542 is provided in a first direction D1 toward the calibrated image 1502 for the third visual object 1530, the third visual object 1530 may move in the first direction D1. In this case, the area of the calibrated image 1502 may be decreased, and the area of the original image 1501 may be increased. In a case that the drag input 1542 is provided in a second direction D2 toward the original image 1501 for the third visual object 1530, the third visual object 1530 may move in the second direction D2. In this case, the area of the calibrated image 1502 may be increased, and the area of the original image 1501 may be decreased. However, the operation of the display 230 displaying each of the original image 1501 and the calibrated image 1502 is not limited thereto. Although not illustrated, the at least one processor 220 may also display the entire original image 1501 and the entire calibrated image 1502 on the display 230. Since each of the original image 1501 and the calibrated image 1502 is displayed on the display 230, the user may intuitively recognize an enhancement effect of a first region 310 in the calibrated image 1502.

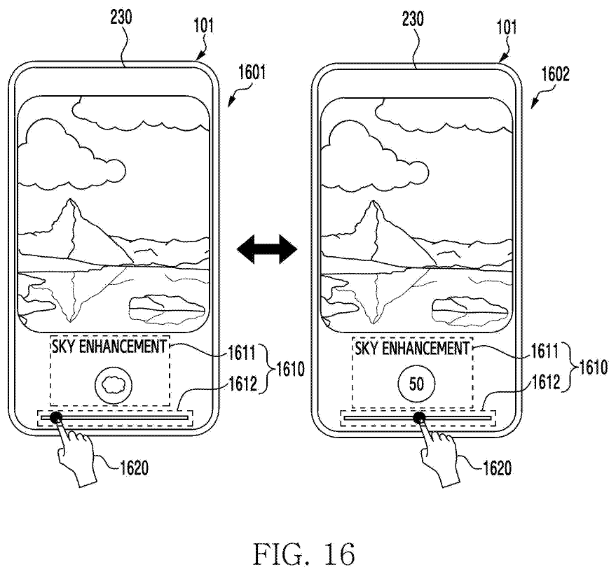

FIG. 16 illustrates a display displaying a fourth visual object according to an embodiment of the disclosure.

Referring to FIG. 16, an electronic device 101 according to an embodiment may be configured to display a fourth visual object 1610 on a display 230 to receive a second user input 1620 for adjusting a degree of enhancement of a first region 310 of a calibrated image.

According to an embodiment of the disclosure, at least one processor (e.g., the at least one processor 220 of FIG. 2) may be configured to display the fourth visual object 1610 on the display 230 for adjusting a second color to be changed from a first color. For example, the fourth visual object 1610 may include an adjustment bar 1612 to select the second color to be changed from the first color of the first region 310 or to adjust a degree of change from the first color. For example, the adjustment bar 1612 may determine a degree of the change of the first color based on the second user input 1620, and the second color may be determined according to the second user input 1620 to the adjustment bar 1612.

Referring to an example 1601 of FIG. 16, the at least one processor 220 may be configured to display an original image and the fourth visual object 1610 on the display 230. The user may provide the second user input 1620 for adjusting the second color to be changed from the first color through the fourth visual object 1610. Referring to an example 1602 of FIG. 16, the fourth visual object 1610 may be changed based on the second user input 1620 for the fourth visual object 1610. For example, within a second maximum calibration value, the fourth visual object 1610 may include the adjustment bar 1612 to represent the second color selected by the user and a text 1611 representing the second color numerically, but is not limited thereto. For example, the number may be referred to as a histogram stretching value or a scaling value of an RGB channel. The at least one processor 220 may generate a calibrated image based on a histogram stretching value or a scaling value of an RGB channel selected by the user, and display the calibrated image on the display 230.

The electronic device 101 according to an embodiment may change the first color into the second color determined by the selection of the user. As a degree of enhancement of the first region 310 is adjusted by the selection of the user, a calibrated image according to a preference of the user may be provided.

An electronic device 101 is provided. The electronic device 101 may include at least one processor 220. The electronic device 101 may include memory 210 including one or more storage media storing instructions. The instructions, when executed individually or collectively by the at least one processor 220, may cause the electronic device 101 to estimate, from an image stored in the memory 210 by using a first artificial intelligence model, a first region 310 in which a defined object 330 is included, and a second region 320 distinct from the first region 310. The instructions, when executed individually or collectively by the at least one processor 220, may cause the electronic device 101 to change a first luminance of pixels to a second luminance, based on a reference luminance 500, to shift a luminance distribution range of the pixels (e.g., first pixels) included in the first region 310. The instructions, when executed individually or collectively by the at least one processor 220, may cause the electronic device 101 to change a first color of at least one pixel among the pixels to a second color such that a luminance deviation of the pixels is increased. The instructions, when executed individually or collectively by the at least one processor 220, may cause the electronic device 101 to provide a calibrated image for the image by changing a color of at least one pixel among the pixels to a third color based on a weighted sum of the first color and the second color.

According to an embodiment of the disclosure, the instructions, when executed individually or collectively by the at least one processor 220, may cause the electronic device 101 to detect the defined object 330 from the image, by using a second artificial intelligence model. The instructions, when executed individually or collectively by the at least one processor 220, may cause the electronic device 101 to, based on the detection of the defined object 330, provide the calibrated image.

According to an embodiment of the disclosure, the instructions, when executed individually or collectively by the at least one processor 220, may cause the electronic device 101 to, based on identifying, by using the second artificial intelligence model, that a ratio of an area of the defined object 330 to an area of the first region 310 is greater than or equal to a defined ratio, detect the defined object 330.

According to an embodiment of the disclosure, the at least one pixel which is changed to the third color may contact pixels (e.g., second pixels) included in the second region 320 among the pixels.

According to an embodiment of the disclosure, a weight of the weighted sum may be determined based on a ratio of the number of the pixels included in the first region 310 and the number of pixels included in the second region 320, included in a defined range from the at least one pixel changed to the third color.

According to an embodiment of the disclosure, the instructions, when executed individually or collectively by the at least one processor 220, may cause the electronic device 101 to obtain a segmentation mask in accordance with the first region 310 and the second region 320, by using the first artificial intelligence model. The instructions, when executed individually or collectively by the at least one processor 220, may cause the electronic device 101 to, based on identifying an error in the segmentation mask, obtain an edge map based on objects in the image. The instructions, when executed individually or collectively by the at least one processor 220, may cause the electronic device 101 to calibrate the estimated first region 310 and the second region 320, by removing the error based on the segmentation mask and the edge map.

According to an embodiment of the disclosure, the instructions, when executed individually or collectively by the at least one processor 220, may cause the electronic device 101 to compare a difference between the first luminance and the second luminance with a defined first maximum calibration value. The instructions, when executed individually or collectively by the at least one processor 220, may cause the electronic device 101 to, based on identifying the difference lower than or equal to the first maximum calibration value, change the first luminance to the second luminance. The instructions, when executed individually or collectively by the at least one processor 220, may cause the electronic device 101 to, based on identifying the difference that is less than the first maximum calibration value, change the first luminance based on the first maximum calibration value.

According to an embodiment of the disclosure, the instructions, when executed individually or collectively by the at least one processor 220, may cause the electronic device 101 to determine the first maximum calibration value based on a luminance distribution range of pixels included in a region corresponding to the first region 310, in at least one favorite image stored in the memory 210.

According to an embodiment of the disclosure, the instructions, when executed individually or collectively by the at least one processor 220, may cause the electronic device 101 to compare a difference between the first color and the second color with a defined second maximum calibration value. The instructions, when executed individually or collectively by the at least one processor 220, may cause the electronic device 101 to, based on identifying the difference lower than or equal to the second maximum calibration value, change the first color to the second color. The instructions, when executed individually or collectively by the at least one processor 220, may cause the electronic device 101 to, based on identifying the difference that is less than the maximum calibration value (e.g., a first and/or a second maximum calibration values), change the first color based on the second maximum calibration value.

According to an embodiment of the disclosure, the instructions, when executed individually or collectively by the at least one processor 220, may cause the electronic device 101 to determine the second maximum calibration value based on a luminance deviation of pixels included in a region corresponding to the first region 310, in at least one favorite image stored in the memory 210.

According to an embodiment of the disclosure, the instructions, when executed individually or collectively by the at least one processor 220, may cause the electronic device 101 to determine the reference luminance 500, based on a luminance distribution range of pixels included in a region corresponding to the first region 310, in at least one favorite image stored in the memory 210. The instructions, when executed individually or collectively by the at least one processor 220, may cause the electronic device 101 to determine the second color based on a luminance deviation of the pixels included in the region corresponding to the first region 310, in the favorite images.

According to an embodiment of the disclosure, the electronic device 101 may further include a display 230 for displaying the image. The instructions, when executed individually or collectively by the at least one processor 220, may cause the electronic device 101 to display a first visual object 1510 on the display 230 for receiving a first user input 1541 for requesting generation of the calibrated image. The instructions, when executed individually or collectively by the at least one processor 220, may cause the electronic device 101 to generate the calibrated image based on receiving the first user input 1541 for the first visual object 1510.

According to an embodiment of the disclosure, the electronic device 101 may further include a display 230 for displaying the image. The instructions, when executed individually or collectively by the at least one processor 220, may cause the electronic device 101 to display a second visual object 1520 on the display 230 to indicate that the image is being calibrated, while the calibrated image is being generated.

According to an embodiment of the disclosure, the electronic device 101 may further include a display 230 for displaying the image. The instructions, when executed individually or collectively by the at least one processor 220, may cause the electronic device 101 to display a portion of the image and a portion of the calibrated image respectively on the display 230, based on generating the calibrated image. The instructions, when executed individually or collectively by the at least one processor 220, may cause the electronic device 101 to display a third visual object 1530 for adjusting an area of the portion of the image and the portion of the calibrated image.

According to an embodiment of the disclosure, the electronic device 101 may further include a display 230 for displaying the image. The instructions, when executed individually or collectively by the at least one processor 220, may cause the electronic device 101 to display a fourth visual object 1610 on the display 230 for receiving a second user input 1620 for adjusting the second color to be changed. The instructions, when executed individually or collectively by the at least one processor 220, may cause the electronic device 101 to determine the second color based on the second user input 1620 for the fourth visual object 1610.

A method performed by an electronic device 101 including memory 210 is provided. The method may include estimating, from an image stored in the memory 210 by using a first artificial intelligence model, a first region 310 in which a defined object 330 is included, and a second region 320 distinct from the first region 310. The method may include changing a first luminance of pixels to a second luminance, based on a reference luminance 500, to shift a luminance distribution range of the pixels included in the first region 310. The method may include changing a first color of at least one pixel among the pixels to a second color such that a luminance deviation of the pixels is increased. The method may include providing a calibrated image for the image by changing a color of at least one pixel among the pixels to a third color based on a weighted sum of the first color and the second color.

According to an embodiment of the disclosure, the method may further include detecting the defined object 330 from the image, by using a second artificial intelligence model. The method may further include providing the calibrated image, based on the detection of the defined object 330. According to an embodiment of the disclosure, the method may further include obtaining a segmentation mask in accordance with the first region 310 and the second region 320, by using the first artificial intelligence model. The method may further include, based on identifying a hole in the segmentation mask, obtaining an edge map based on objects in the image. The method may further include calibrating the estimated first region 310 and the second region 320, by removing the hole based on the segmentation mask and the edge map.

According to an embodiment of the disclosure, the method may further include comparing a difference between the first luminance and the second luminance with a defined first maximum calibration value. The method may further include, based on identifying the difference lower than or equal to the first maximum calibration value, changing the first luminance to the second luminance. The method may further include, based on identifying the difference that is less than the first maximum calibration value, changing the first luminance based on the first maximum calibration value.

According to an embodiment of the disclosure, the method may further include comparing a difference between the first color and the second color with a defined second maximum calibration value. The method may further include, based on identifying the difference lower than or equal to the second maximum calibration value, changing the first color to the second color. The method may further include, based on identifying the difference that is less than the maximum calibration value, changing the first color based on the second maximum calibration value.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs including instructions that, when executed, implement various embodiments of the disclosure. Accordingly, various embodiments provide a program including code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor; and
memory comprising one or more storage media storing instructions,
wherein the instructions, when executed by the at least one processor individually or collectively, cause the electronic device to:
estimate, from an image stored in the memory by using a first artificial intelligence model, a first region in which a defined object is included, and a second region distinct from the first region,
change a first luminance of first pixels included in the first region to a second luminance, based on a reference luminance, to shift a luminance distribution range of the first pixels included in the first region,
change a first color of at least one pixel among the first pixels to a second color such that a luminance deviation of the first pixels is increased, and
provide a calibrated image for the image by changing a color of at least one pixel among the first pixels to a third color based on a weighted sum of the first color and the second color.

2. The electronic device of claim 1, wherein the instructions, when executed by the at least one processor individually or collectively, cause the electronic device to:
detect the defined object from the image, by using a second artificial intelligence model, and
based on the detection of the defined object, provide the calibrated image.

3. The electronic device of claim 2, wherein the instructions, when executed by the at least one processor individually or collectively, cause the electronic device to:
based on identifying, by using the second artificial intelligence model, that a ratio of an area of the defined object to an area of the first region is greater than or equal to a defined ratio, detect the defined object.

4. The electronic device of claim 1, wherein the at least one pixel which is changed to the third color contacts second pixels included in the second region.

5. The electronic device of claim 1, wherein a weight of the weighted sum is determined based on a ratio of the number of the first pixels to the number of pixels included in a defined range from the at least one pixel changed to the third color.

6. The electronic device of claim 1, wherein the instructions, when executed by the at least one processor individually or collectively, cause the electronic device to:
obtain a segmentation mask in accordance with the first region and the second region, by using the first artificial intelligence model,
based on identifying an error in the segmentation mask, obtain an edge map based on objects in the image, and
calibrate the estimated first region and the second region, by removing the error based on the segmentation mask and the edge map.

7. The electronic device of claim 1, wherein the instructions, when executed by the at least one processor individually or collectively, cause the electronic device to:
compare a difference between the first luminance and the second luminance with a defined first maximum calibration value,
based on identifying the difference lower than or equal to the first maximum calibration value, change the first luminance to the second luminance, and
based on identifying the difference that exceeds the first maximum calibration value, change the first luminance based on the first maximum calibration value.

8. The electronic device of claim 7, wherein the instructions, when executed by the at least one processor individually or collectively, cause the electronic device to:
determine the first maximum calibration value based on a luminance distribution range of pixels included in a region corresponding to the first region, in at least one favorite image stored in the memory.

9. The electronic device of claim 1, wherein the instructions, when executed by the at least one processor individually or collectively, cause the electronic device to:
compare a difference between the first color and the second color with a defined second maximum calibration value,
based on identifying the difference lower than or equal to the second maximum calibration value, change the first color to the second color, and
based on identifying the difference that exceeds the second maximum calibration value, change the first color based on the second maximum calibration value.

10. The electronic device of claim 9, wherein the instructions, when executed by the at least one processor individually or collectively, cause the electronic device to:
determine the second maximum calibration value based on a luminance deviation of pixels included in a region corresponding to the first region, in at least one favorite image stored in the memory.

11. The electronic device of claim 1, wherein the instructions, when executed by the at least one processor individually or collectively, cause the electronic device to:
determine the reference luminance, based on a luminance distribution range of pixels included in a region corresponding to the first region, in at least one favorite image stored in the memory, and
determine the second color based on a luminance deviation of the pixels included in the region corresponding to the first region, in the at least one favorite image.

12. The electronic device of claim 1, further comprising:
a display for displaying the image,
wherein the instructions, when executed by the at least one processor individually or collectively, cause the electronic device to:
display a first visual object on the display for receiving a first user input for requesting generation of the calibrated image, and
generate the calibrated image based on receiving the first user input for the first visual object.

13. The electronic device of claim 1, further comprising:
a display for displaying the image,
wherein the instructions, when executed by the at least one processor individually or collectively, cause the electronic device to:
display a second visual object on the display to indicate that the image is being calibrated, while the calibrated image is being generated.

14. The electronic device of claim 1, further comprising:
a display for displaying the image,
wherein the instructions, when executed by the at least one processor individually or collectively, cause the electronic device to:
display a portion of the image and a portion of the calibrated image respectively on the display, based on generating the calibrated image, and
display a third visual object for adjusting an area of the portion of the image and the portion of the calibrated image.

15. The electronic device of claim 1, further comprising:
a display for displaying the image,
wherein the instructions, when executed by the at least one processor individually or collectively, cause the electronic device to:
display a fourth visual object on the display for receiving a second user input for adjusting the second color to be changed, and
determine the second color based on the second user input for the fourth visual object.

16. A method performed by an electronic device comprising memory, the method comprising:
estimating, from an image stored in the memory by using a first artificial intelligence model, a first region in which a defined object is included, and a second region distinct from the first region;
changing a first luminance of first pixels included in the first region to a second luminance, based on a reference luminance, to shift a luminance distribution range of the first pixels included in the first region;
changing a first color of at least one pixel among the first pixels to a second color such that a luminance deviation of the first pixels is increased; and
providing a calibrated image for the image by changing a color of at least one pixel among the first pixels to a third color based on a weighted sum of the first color and the second color.

17. The method of claim 16, further comprising:
detecting the defined object from the image, by using a second artificial intelligence model; and
providing the calibrated image, based on the detection of the defined object.

18. The method of claim 16, further comprising:
obtaining a segmentation mask in accordance with the first region and the second region, by using the first artificial intelligence model;
based on identifying an error in the segmentation mask, obtaining an edge map based on objects in the image; and
calibrating the estimated first region and the second region, by removing the error based on the segmentation mask and the edge map.

19. The method of claim 16, further comprising:
comparing a difference between the first luminance and the second luminance with a defined first maximum calibration value;
based on identifying the difference lower than or equal to the first maximum calibration value, changing the first luminance to the second luminance; and
based on identifying the difference that exceeds the first maximum calibration value, changing the first luminance based on the first maximum calibration value.

20. The method of claim 16, further comprising:
comparing a difference between the first color and the second color with a defined second maximum calibration value;
based on identifying the difference lower than or equal to the second maximum calibration value, changing the first color to the second color; and
based on identifying the difference that exceeds the second maximum calibration value, changing the first color based on the second maximum calibration value.
